(19) United States
(12) Patent Application Publication
(10) Pub. No.: US 2013/0110688 A1
(43) Pub. Date: May 2, 2013

(54) Power System for Mobile Devices

(71) Applicant: Witapper, LLC, Rockwall, TX (US)

(72) Inventor: Ryan Moorman, Rockwall, TX (US)

(73) Assignee: WITAPPER, LLC, Rockwall, TX (US)

(21) Appl. No.: 13/663,013

(22) Filed: Oct. 29, 2012

Related U.S. Application Data
(60) Provisional application No. 61/554,335, filed on Nov. 1, 2011.

(51) Int. Cl. G06Q 20/14; H02B 1/24; G06Q 20/22

(52) U.S. Cl. 705/34; 705/39; 307/116

(57) ABSTRACT

An apparatus, method, and system for a local power controller to power and/or charge a user device. The local power controller receives a recharging request for the user device, and enables a timed charge for the user device by a power station. Upon completion of the timed charge or upon disconnection of the user device, the local power controller initiates a payment for the timed charge. A maximum amount may be set by the user device. The recharging request may be transmitted by the user device over a cellular communication path.

This application claims the benefit of U.S. Provisional Application No. 61/554,335, entitled “Power System for Mobile Devices,” filed on Nov. 1, 2011, which is incorporated herein by reference.

### BACKGROUND

As devices such as cellular telephones, notebook computers, and even electric vehicles find rapidly growing utilization in technologically advanced economies, there is a corresponding need to provide publicly accessible charging facilities to replenish stored charge in the batteries that enable their operation. Such publicly accessible charging facilities are not yet widely available in public locations, which often constrain utilization of such devices.

Earlier use of such mobile devices was often confined to a home or office environment where charging facilities are easily provided for personal use, thereby limiting use away from the office and home. However, as our working habits become decoupled from homes and from ordinary places of business, the need for public access to charging facilities becomes similarly distributed.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate drawings of a mobile or portable device charging system, in accordance with an embodiment;

FIG. 3 illustrates a sequence of steps to recharge a portable or movable user device, in accordance with an embodiment; and

FIGS. 4 and 5 illustrate drawings of a mobile or portable device charging system, in accordance with an embodiment.

Corresponding numerals and symbols in the different figures generally refer to corresponding parts unless otherwise indicated, and may not be redescribed in the interest of brevity after the first instance. The FIGURES are drawn to illustrate clearly the relevant aspects of exemplary embodiments.

### DETAILED DESCRIPTION OF ILLUSTRATIVE EMBODIMENTS

The making and using of the embodiments are discussed in detail below. It should be appreciated, however, that the present disclosure provides many applicable inventive concepts that can be embodied in a wide variety of specific contexts. The specific embodiments discussed herein are merely illustrative of specific ways to make and use embodiments, and do not limit the scope of the disclosure.

Generally, as will be discussed in greater detail below, a process and apparatus are introduced herein to provide access to a power facility with, optionally, an authorization and a billing arrangement are provided. Embodiments may be used to provide, for example, a power station to enable a user device, such as a mobile device (e.g., cellular telephones, portable computers, electric vehicles, or the like) to be powered and/or recharged. Embodiments provide a mechanism to identify and enable a charger (e.g., a USB port, a power outlet or other power source) as well as an authorization account, such as a credit-card, debit-card account, bank account, a prepaid account, authorization account, or the like. In an embodiment, the power station may be authorized for a predetermined maximum time period, a predetermined maximum time duration, maximum dollar amount, or the like. Other authorization schemes may be used. Power may be provided via an existing power source to provide energy to the charger. A billing system may be used to accommodate a transfer of funds from the authorization account. In another embodiment, a user may be billed the appropriate amount for payment.

Power may be provided to the device through a hard-wired connection to the device, or through a wireless connection, such as a wireless charging pad.

In an embodiment, the power station may be enabled in response to a wireless request input from the device, and optionally upon verification of the authorization account. The power time period/time duration may be initiated by a local pad/charge controller upon detection of the user device in a power station at the power facility. The timed charge can be terminated by the local pad/charge controller upon completion of the set maximum duration of the timed charge. Alternatively, the timed charge can be terminated upon disconnection of the user device from the power station or upon termination of a current flowing from the power station. After termination of the timed charge, the funds, as determined by the timed charge, may be transferred from a provider's account. A pre-paid account may also be used.

The user device that provides authorization and billing access for the central account to the user account can be configured to enable the user to provide the necessary authorization and billing data to power and/or charge the user device.

A printed receipt for transferred funds can be provided locally at the power facility, or alternatively, an e-mail receipt for the transferred funds can be sent to a specified e-mail address.

In an embodiment, a web site may be provided to allow a user to locate a power station. The location may be based upon the user's location, and obtain therefrom the location of a nearby publicly accessible power facility in which the user can access, e.g., to recharge a mobile device. The user's location can be determined by a GPS application or by determination of the user's location by a serving network element such as a base station or a router. Alternatively, the user can enter its location into a software application so that the user's location can be transmitted to the website.

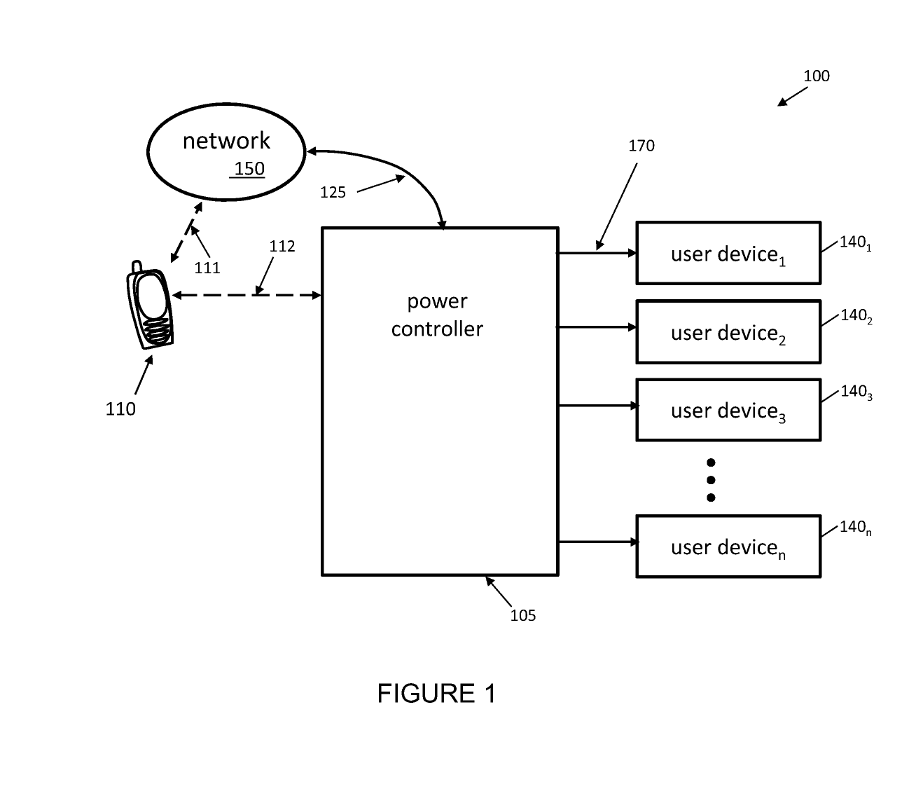

Turning now to FIG. 1, illustrated is a power supply system 100, in accordance with an embodiment. The power supply system 100 comprises a power controller 105 providing one or more electrical connections 170 to user devices 140₁-140ₙ (collectively referred to as user devices 140). The one or more electrical connections 170 may be, for example, a wireless power coupling, such as power pad, or a wired coupling, such as wired metallic two or three prong outlet, a USB port, or the like.

A user (not shown) requests the power controller 105 to enable one or more of the electrical connections 170, thereby providing access to power to corresponding ones of the user devices 140₁-140ₙ. In an embodiment, the user requests the power controller 105 to enable one or more of the electrical connections 170 via a requesting device 110, such as a mobile phone, a portable computer, an electrical vehicle, verbal request, a mechanical action (e.g., swiping a credit card, actuating a button/switch, etc.) or the like. It should be noted that the requesting device 110 and the user device 140 may be the same or different devices. The user devices 140 and or the requesting device 110 may be, for example, cellular telephones, portable computers, electric vehicles, other mobile device, other device requiring power, and/or the like.

In an embodiment, the requesting device 110 communicates with the power controller 105 directly (via a wired and/or wireless link illustrated by reference numeral 112) or through a network 150 (via a wired and/or wireless link illustrated by reference numeral 111). The network 150 may include a public service telecommunications network (“PSTN”), a cellular network, a computer network, a WiMAX network, the Internet, or the like. The network 150 may also be an integrated component of the power controller 105, such as a local area network (wired or wireless).

In operation, the user communicates with the power controller 105 to request one or more of the electrical connections 170 be enabled, thereby providing power to corresponding ones of the user devices 140. In this manner, the user devices 140 may be, for example, operated and/or charged. The user may indicate the appropriate electrical connection 170 by any suitable means. For example, in an embodiment, the user may scan a barcode, enter an identifier corresponding to a selected electrical connection 170, or the like. In another embodiment, the power controller 105 may detect an electrical connection between with a user device 140 and automatically enable the appropriate electrical connection 170.

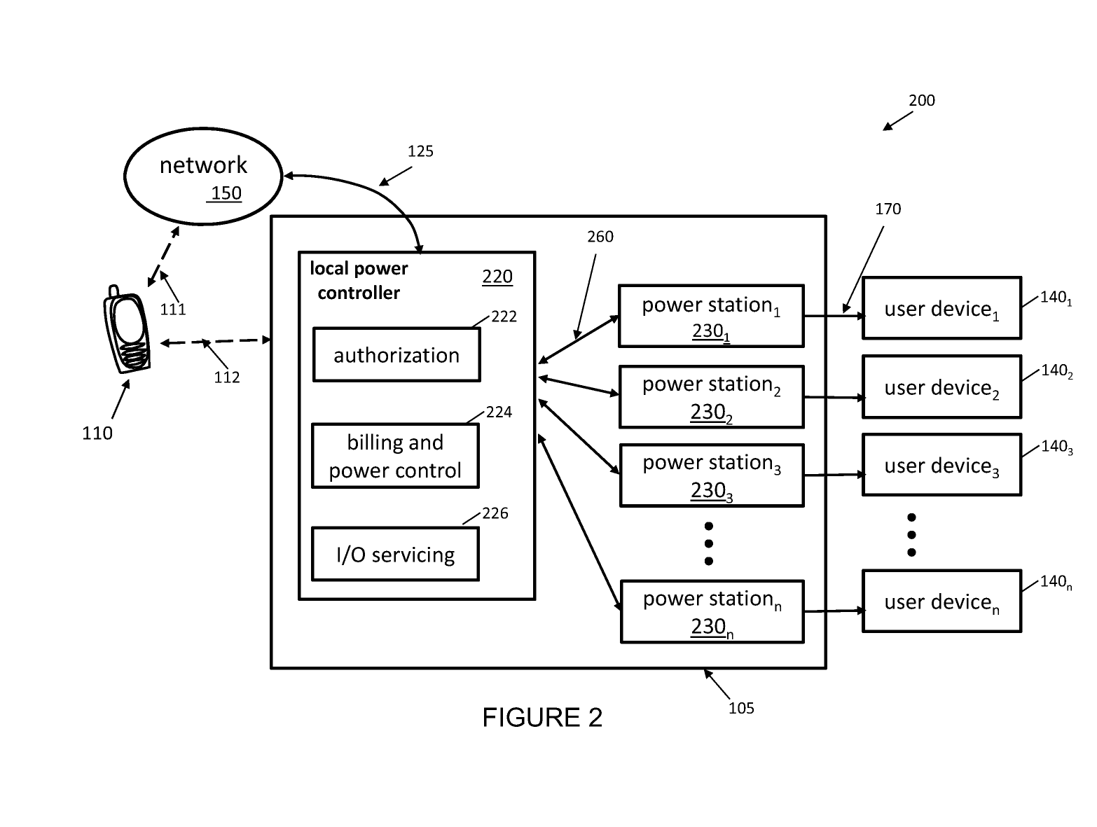

Referring now to FIG. 2, there is shown a power system 200 in which details of the power controller 105 are shown in accordance with an embodiment. For example, FIG. 2 illustrates an embodiment in which the power controller 105 comprises a local power controller 220 coupled to one or more power stations, such as power stations 230₁-230ₙ (collectively referred to as power stations 230). The local power controller 220 communicates via a wired or wireless communication path 260 with the power stations 230 to control the power stations 230 to, e.g., enable/disable the power to enable recharging and/or operation of the user device 140. Thus, an enablement signal or a charge completion signal can be produced by the local power controller 220 for a timed charge for the user device 140.

FIG. 2 further illustrates that the local power controller 220 may comprise an authorization component 222, a billing and power control component 224 and I/O servicing component 226. The authorization component 222 acquires and validates user and/or billing information for a user device to be recharged. The billing and power control 224 provides accounting for use of the power station 230, such as accounting for a recharging time interval, e.g., a start time and a stop time, for a particular power station and to accumulate billing information therefor. The billing system and power control component 224 provides an interface with individual power stations to enable a particular power station and to identify periods of time during which recharging (or use) of the user device takes place. The input/output (“I/O”) servicing component 226 enables the previous two processes to communicate with external system elements such as a telecommunications network and a printer, and to provide testing capability for the local power controller 220.

It should be noted that these components are provided for illustrative purposes only to better illustrate operations and capabilities of the power system. Additionally, it should be noted that the individual components of the power system may be centrally located or decentralized.

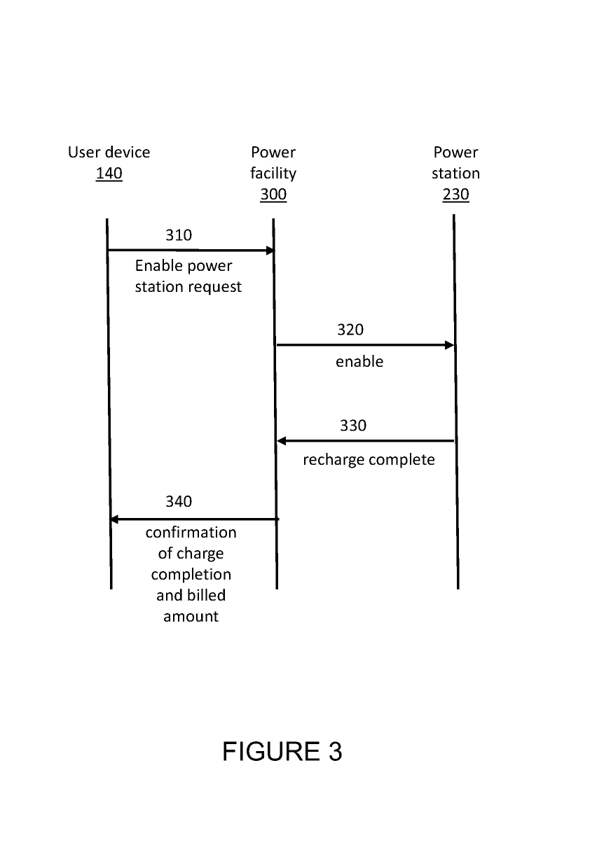

Turning now to FIG. 3, illustrated is a sequence of steps 300 to provide power to a user device 140 in accordance with an embodiment. The power facility 300 represents one or more of the components of, for example, the power system 100 of FIG. 1, the power system 200 of FIG. 2, or another embodiment. The power facility 300 may further represent portions of the network 150 and the power controller 105. It is also noted that the power station 230 is shown as a separate element in FIG. 3 to better illustrate the control of the power station 230. As discussed herein, the networking and the configuration of the system may take many forms. The steps illustrated in FIG. 3 are provided for illustrative purposes only, and other messages or signaling may be used. It should be appreciated that many different embodiments may utilize different configurations. As such, the steps illustrated in FIG. 3 are simplified to better illustrate an embodiment.

In step 310, a user device, e.g., user device 140, sends an enable power station request to a power facility. The enable power station request may include an identification of a user account, an identification of the power station, e.g., power station 230, other information, and/or the like. The enable power station request may be issued in any suitable manner. For example, in an embodiment, the user navigates to a particular web page or application and enters the appropriate information of the user, such as user identification, credit card information, account information, and/or the like, and/or appropriate information of the power station, e.g., bar code, location information, station identifier, and/or the like.

Upon receipt of the enable power station request 310, the power facility 300 evaluates the request and, if appropriate, enables a power station. The power facility 300 may validate the user information and/or the power station information, which may include validating payment information and/or authorizing the user. As discussed above, this process may involve the power system 300 charging a user's credit card account.

In step 320, in response to the enable request, the power facility 300 enables the power station 230 to supply power to a user device 140 for, e.g., a period of time. The power station 230 may be enabled according to any suitable method. For example, in an embodiment, a maximum amount for the transfer of funds can be set by the user device, and a corresponding maximum power time for the power station 230 can be set dependent on the maximum amount that was set for the transfer of funds.

Optionally, in step 330, the power station 230 signals the power facility when charging has terminated. As discussed above, the power station 230 may be enabled for a fixed period of time or a variable period of time. In an embodiment in which the power station 230 is enabled for a variable period of time, the power station 230 may signal the power facility the occurrence of an event, such as detecting that the user device 140 is no longer drawing power from the power station 230. It should be noted that other billing arrangements may be utilized.

In step 340, the power facility 300 may optionally signal a confirmation of use of the power station and/or a billed amount to the user device. The billed funds may be transferred from the user's account to a central account associated with the charging facility or an appropriate amount may be billed to the user. The period of time during which the user device 140 utilized power may also be signaled. It should be noted that other billing arrangements may be utilized. For example, a user may pay for a specific time period, a user may pay for the amount of power utilized, or the like.

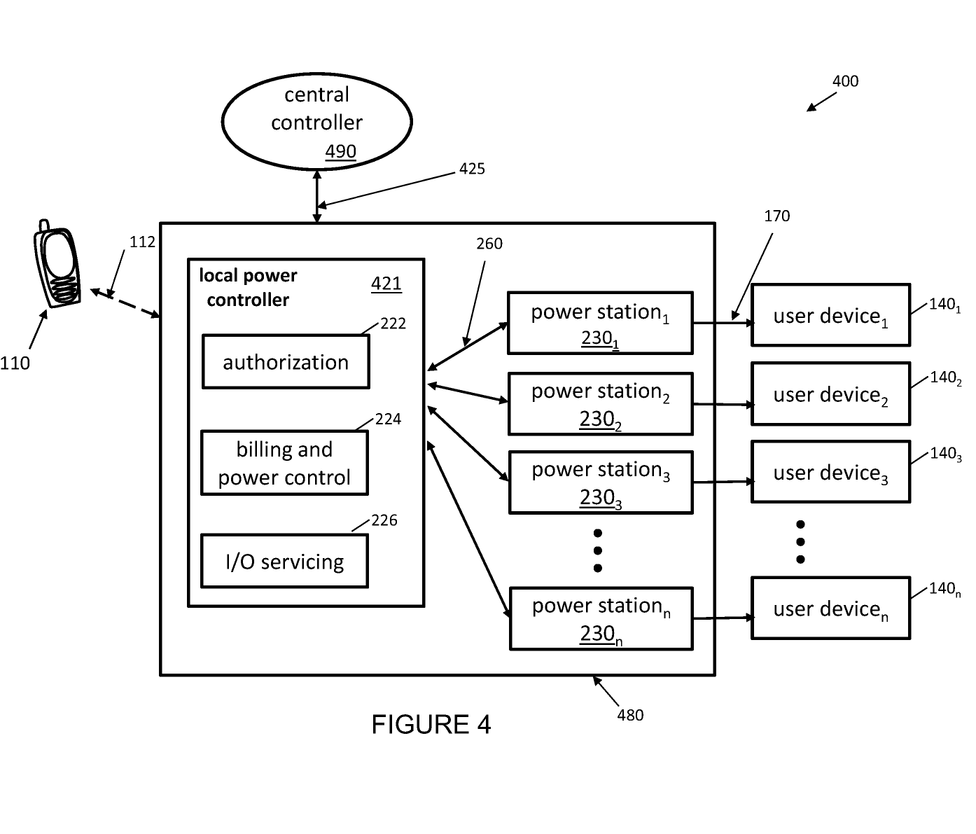

Turning now to FIG. 4, illustrated is a power system 400, in accordance with another embodiment. In the power system 400 illustrated in FIG. 4, local power controller 421 and the power stations 230, are integrated into a common power unit 480. The common power unit 480 may include with a central controller 490 that accumulates billing information for one or more common power units 480. Alternatively the central controller 490 can be constructed separate from the common power unit 480, as illustrated in FIG. 4. As illustrated in FIG. 4, the user device 140 such as a cellular telephone 110 or the like communicates directly with the local power controller 421 over a wireless communication path such as a cellular, WiMAX, Wi-Fi, Bluetooth communication path, or the like, or a wired communications path.

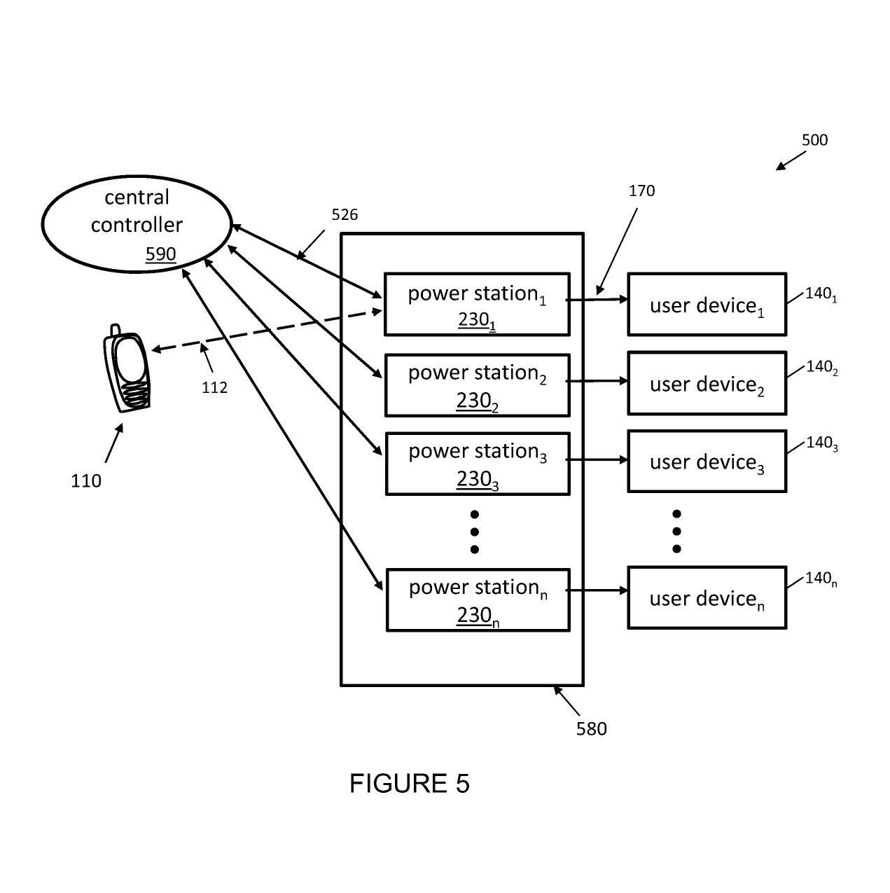

Turning now to FIG. 5, illustrated is a power system 500, in accordance with an embodiment. In the power system 500 illustrated in FIG. 5, the local power controller such as local power controller 220 or 421 is integrated into each of the power stations, e.g., power stations 230. The central controller 590 may be collocated with the power stations 230, or may be located separately from the power stations 230. The power stations 230 can communicate with the central controller 590 over a switched PSTN communication path, a cellular communication path, an Internet connection, or the like.

In an embodiment, a method comprising receiving a request to enable a power station, the request including an identifier of the power station and enabling the power station in response to the request is provided.

In another embodiment, an apparatus comprising a power controller; and a power station communicatively coupled to the power controller, the local power controller enabling the power station in response to an enable power station request is provided.

Program or code segments making up the various embodiments may be stored in a transitory or non-transitory computer readable medium or transmitted by a computer data signal embodied in a carrier wave, or a signal modulated by a carrier, over a transmission medium. For instance, a computer program product including a program code stored in a computer readable medium (e.g., a non-transitory computer readable medium) may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

As described above, the embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
receiving a request to enable a power station, the request including an identifier of the power station; and
enabling the power station in response to the request.

2. The method of claim 1, further comprising initiating a payment for a timed charge.

3. The method of claim 2, wherein the initiating the payment comprises:
determining a period of time the power station was enabled; and
requesting the payment dependent on the period of time.

4. The method of claim 2, wherein the payment is based upon an amount of power provided by the power station.

5. The method of claim 1, wherein the enabling comprises enabling the power station for a fixed period of time.

6. The method of claim 1, further comprising:
identifying an account associated with the request for the initiating the payment; and
verifying the account.

7. The method of claim 1, wherein the power station is controlled by a wireless communication path from a local power controller.

8. The method of claim 1, wherein the request to enable the power station is transmitted over a cellular communication path.

9. The method of claim 1, further comprising:
determining a maximum amount for use of the power station; and
limiting a maximum power time for the power station dependent on the maximum amount.

10. The method of claim 9, wherein an indication of the maximum amount is received from the user device.

11. The method of claim 1, wherein power is supplied by the power station via a wireless charging pad.

12. An apparatus, comprising:
a power controller; and
a power station communicatively coupled to the power controller, the local power controller enabling the power station in response to an enable power station request.

13. The apparatus of claim 12, wherein the power controller transmits an indication of a payment amount.

14. The apparatus of claim 13, wherein the payment amount is dependent on a time period the power station was enabled.

15. The apparatus of claim 13, wherein the payment amount is dependent on an amount of power provided by the power station.

16. The apparatus of claim 12, wherein the power controller is further configured to:
identify an account associated with the request for to initiate a payment; and
verify the account.

17. The apparatus of claim 12, wherein the power station is controlled by a wireless communication path from the power controller.

18. The apparatus of claim 12, wherein the request to enable the power station is received via cellular communication path.

19. The apparatus of claim 12, wherein the power controller determines a maximum amount for a payment and limits a maximum power time for the power station dependent on the maximum amount.

20. The apparatus of claim 12, wherein the maximum amount is received from the user device.
